(19) United States
(12) Patent Application Publication
(10) Pub. No.: US 2009/0048924 A1
(43) Pub. Date: Feb. 19, 2009

(54) Apparatuses, Systems and Methods for Loading, Activating and Redeeming an Investment Gift Card

(76) Inventors: Elizabeth E. Wiborg, Plainfield, IL (US); Nicole D. Murray, Joliet, IL (US)

Correspondence Address: MCANDREWS HELD & MALLOY, LTD, 500 WEST MADISON STREET, SUITE 3400, CHICAGO, IL, 60661, US

(21) Appl. No.: 12/190,218

(22) Filed: Aug. 12, 2008

Related U.S. Application Data
(60) Provisional application No. 60/955,810, filed on Aug. 14, 2007.

(51) Int. Cl. G06Q 40/00; G06Q 10/00; G06Q 20/00; G06Q 30/00

(52) U.S. Cl. 705/14; 705/41; 705/30; 705/17

(57) ABSTRACT

Embodiments of the present technology provide apparatuses, systems and methods for loading, activating, and redeeming an investment gift card.

### RELATED APPLICATIONS

This application claims benefit under 35 U.S.C. §119(e) to U.S. Provisional Patent Application No. 60/955,810, filed Aug. 14, 2007, which is incorporated by reference herein in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Generally, the technical field involves apparatuses, systems and methods for loading, activating, and redeeming an investment gift card.

Today, the number of people investing in the financial markets is a small percentage of the overall population of America. In late 2005, 30% of Americans earning below $50,000 invested, according to www.nationalreview.com. In 2006, the United States Census Bureau determined the median annual household income to be $48,201. According to a 2007 collegeboard.com article, the average annual tuition for an in-state public college was over $6,000, and was over $23,000 annually for a private college.

Individuals have a desire to save or invest money for a variety of reasons. Many parents want to save or invest to meet rising college expenses. College expenses have risen nearly 51% over the past decade. In 1997, the Taxpayer Relief Act created a plan known as “a 529 college savings plan” in response to these rising prices. Since the creation of the 529 plan program, more than 9 million 529 college savings accounts have been opened. The average 529 college savings plan balance hovers around $12,500. The assets in these savings plans are expected to grow to over $110 billion by the end of 2007.

When giving gifts to friends or family, the giver typically wants to give something creative, meaningful and useful. This can be difficult. The giver may not know what items the recipient already has or what he or she wants or needs. Also, there are certain occasions where the giver may not want to give a toy or material gift, such as to celebrate religious occasions or reward academic achievements. The giver also may not want to simply give money or a check for fear it will seem impersonal.

Gift cards have become largely popular in recent years due to these difficulties in gift giving. In 2006, it was estimated that there were over $80 billion in gift card sales in the United States. In fact, gift card sales grew 34% in 2006 to become the top retail product category. To add to their convenience, gift cards can now be purchased online or at a retailer other than the store where the respective gift card is to be redeemed, for example at a supermarket or convenience store. In 2006, 17.7% of gift cards were purchased online and 17.3% were purchased in a retail store other than that where it would be redeemed.

### BRIEF SUMMARY OF THE INVENTION

This present disclosure relates to an apparatus, system and method of loading/activating/using a gift card with funds to be utilized toward the purchase of an investment option. Specifically, this disclosure involves a marketing method to link the gift card industry with the 529 college savings industry. This union will provide a meaningful gift and a convenient avenue for investing in 529 college savings accounts.

A large number of individuals would like to save but, for various reasons, do not. These individuals may not have extra money to save, they may have questions about investing, or may be afraid to invest their “own money” in the financial market. The investment gift card of the current disclosure helps introduce individuals to investing and makes investing in financial markets very easy.

Gift cards have been disclosed in patent applications in the past. For example, U.S. Publication No. 2007/063020 (Barrafato) deals with Systems and Methods for Charity Gift Cards. U.S. Publication 2007/0162338 (Lawe) deals with a US Savings Bond Gift System and Method to Redeem a Gift Card for a US Savings Bond Through Internet Redemption. U.S. Publication No. 2007/0185810 (Kalra) deals with a System, Method and Computer Program Product for Saving and Investing Through the Use of Transaction Cards. U.S. Publication No. 2007/0288340 (Kravitz) deals with a Pre-Paid Financial Savings and Investment System. However, the apparatuses and/or systems disclosed in these applications do not, inter alia, allow the gift card recipient to redeem the gift card using the financial institution, financial advisor and/or financial planner of his/her choice rather financial service providers with whom the gift card provider has relationships. These applications are incorporated by reference herein in their entirety.

The investment gift card can be available at convenient locations. For example the investment gift card could be available online, at a retail outlet, or at other convenient locations. The investment gift card could be available in denominated and non-denominated amounts. The funds loaded onto the investment gift card are routed to a financial account linked to the investment gift card until the funds are redeemed. The investment gift card is redeemed via a convenient option. For example, the investment gift card could be redeemed online, with a call center, or in some other convenient manner. Once redeemed, the investment gift card funds are deposited into a customer specified existing investment account. For example, the funds could be deposited into a 529 college savings account, a mutual fund, or other existing investment account.

An investment gift card would provide an environment where people are helping themselves obtain a college education. The gift giver gets the feeling of helping with the recipient's future, while the recipient receives a financial step toward their future. An investment gift card would begin to educate the youth about the importance of investing and saving early in their life. The investment gift card is also a marketing and education method to introduce the public to 529 college savings accounts.

Certain embodiments of the present technology provide apparatuses, systems and methods for loading, activating, and redeeming an investment gift card.

Certain embodiments of the present system for loading, activating, and redeeming an investment gift card comprise a gift card having an identifier associated with the gift card; a database wherein the database associates the identifier with the gift card; an activation interface wherein the activation interface obtains the identifier associated with the gift card, verifies the identifier is associated with the gift card and associates a denomination of money with the gift card in the database; a storage system wherein the storage system stores the denomination of money until redemption; a redemption interface wherein the redemption interface obtains the identifier associated with the gift card and other redemption information; a router wherein the router routes at least a portion of the denomination of money from the storage system into an existing investment account determined according to the other redemption information. This gift card can be a physical gift card, or an electronic gift card with a unique identifier associated with the transaction.

Examples of potential existing investment accounts include, but are not limited to, 529 college savings plans, IRAs, Roth IRAs, Retirement Accounts, individual stocks, mutual funds, and Exchange Traded Funds (ETFs). The denomination of money associated with the gift card can be customer-specified. The gift card can be personalized using graphics, text, or photos. A themed promotional gift can also be coupled with the gift card.

In some embodiments, the card can be purchased and activated at a retail outlet or online. The activation interface can additionally associate other general transaction information, such as purchaser, date of purchase, time of purchase and method of purchase, with the gift card in the database.

In some embodiments, the card can be redeemed online or using a call center. The redemption interface can obtain redemption information including what portion of the denomination of money is to be routed to the existing investment account, redemption time, redemption date, redemption method, gift card remaining balance, and an identifier associated with the existing investment account. The redemption interface can additionally update the database with redemption information.

In one embodiment, the gift card is re-loadable. In another embodiment, the gift card automatically reloads. The reloading can occur on a regularly scheduled basis. For example, reloading could occur weekly, monthly, quarterly or yearly.

Certain embodiments of the present method of loading, activating, and redeeming an investment gift card comprise assigning an identifier to a gift card; compiling a database wherein the identifier is associated with the gift card; activating the gift card by obtaining the identifier associated with the gift card, verifying the identifier is associated with the gift card and associating a denomination of money with the gift card in the database; storing the denomination of money until redemption; obtaining the identifier associated with the gift card and other redemption information; routing at least a portion of the denomination of money from the storage system into an existing investment account determined according to the other redemption information. The method can be performed sequentially or non-sequentially.

Certain embodiments of the present computer-readable medium have a set of instructions for execution by a computer, the set of instructions comprise an identification routine configured to assign an identifier to a gift card; a compilation routine configured to compile a database wherein the identifier is associated with the gift card; an activation routine configured to activate the gift card by obtaining the identifier associated with the gift card, verifying the identifier is associated with the gift card and associating a denomination of money with the gift card in the database; a storage routine configured to store the denomination of money until redemption; a redemption routine configured to obtain the identifier associated with the gift card and other redemption information; a routing routine configured to route at least a portion of the denomination of money from the storage system into an existing investment account determined according to the other redemption information.

These and other features of the present invention are discussed or apparent in the following detailed description.

### BRIEF DESCRIPTION OF SEVERAL VIEWS OF THE DRAWINGS

FIG. 1 illustrates an apparatus for loading, activating, and redeeming an investment gift card according to an embodiment of the present technology.

FIG. 2 illustrates a system for loading, activating, and redeeming an investment gift card according to an embodiment of the present technology.

FIG. 3 illustrates a flow diagram for a method of loading, activating, and redeeming an investment gift card according to an embodiment of the present technology.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF PREFERRED EMBODIMENTS OF THE INVENTION

The current technology relates to systems and methods for loading, activating, and redeeming an investment gift card. Although certain particulars are used as examples, the current technology should not be viewed as limited to such specific systems. The principles underlying the creation and use of gift cards are generally well known and need not be described in detail here.

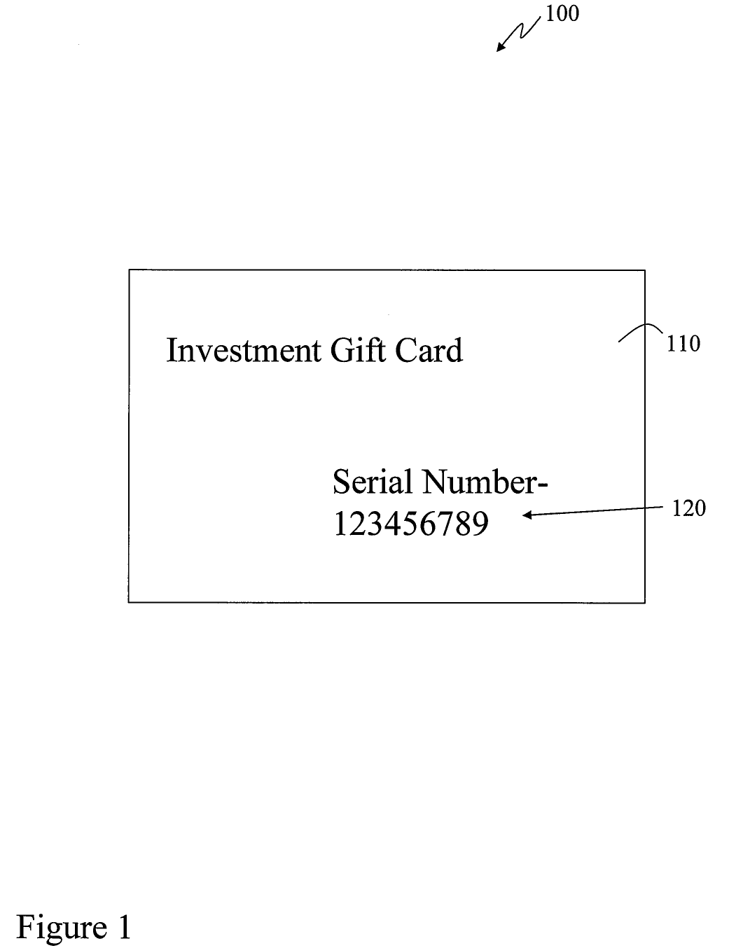

FIG. 1 illustrates an apparatus (100) for loading, activating, and redeeming an investment gift card according to an embodiment of the present technology. The current apparatus (100) comprises an investment gift card (110) with an identifier (120).

In one embodiment the investment gift card (110) could be a plastic card. Typically, gift cards are rectangular and sized appropriately to fit in a credit card slot in a wallet. However, other shapes and sizes are also contemplated. The investment gift card (110) could have information on the front and/or back faces. Such information could include its source, the denomination of the card, how to use the card, etc. In one embodiment, the investment gift card (110) could have themed words or graphics displayed on it. For example, it could have congratulatory words, holiday greetings or other words of encouragement. Graphics could include college mascots or insignias, symbols of certain events (such as a birthday cake, graduation cap, or Christmas tree), or other pictures or advertisements. The investment gift card could also include personalized information and/or photographs and graphics that the user has uploaded onto the card.

In another embodiment, the investment gift card can be in an electronic format. This electronic gift card would not have a physical card but would exist only in its unique identifier. The purchaser would receive the unique identifier. This unique identifier could later be used to redeem the electronic gift card.

The investment gift card (110) would also have an identifier (120). The identifier (120) could be a serial number (as shown), a magnetic strip, a scanable barcode, or other identifier known in the gift card industry. The identifier (120) allows information about the gift card to be recorded and tracked.

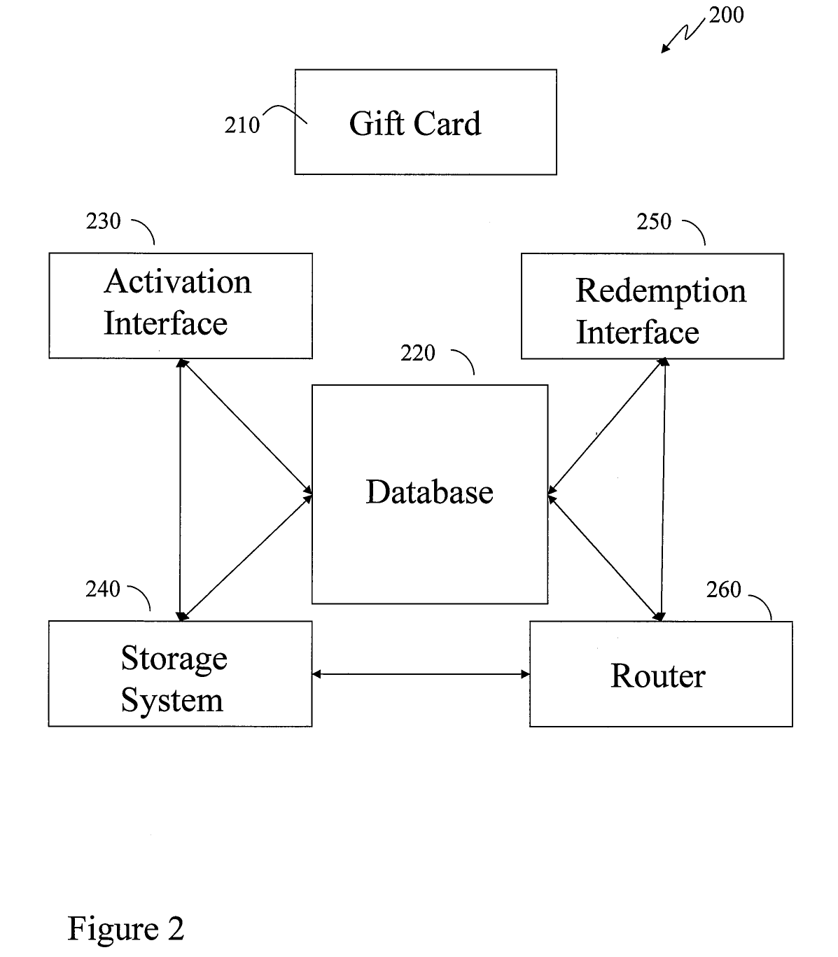

FIG. 2 illustrates a system (200) for loading, activating, and redeeming an investment gift card according to an embodiment of the present technology. In one embodiment, the present system (200) comprises a gift card (210) having an identifier associated with said gift card (210); a database (220) wherein the database (220) associates the identifier with the gift card (210); an activation interface (230) wherein the activation interface (230) obtains the identifier associated with the gift card (210), verifies the identifier is associated with the gift card (210) and associates a denomination of money with the gift card (210) in the database (220); a storage system (240) wherein the storage system (240) stores the denomination of money until redemption; a redemption interface (250) wherein the redemption interface (250) obtains the identifier associated with the gift card (210) and other redemption information; a router (260) wherein the router (260) routes at least a portion of the denomination of money from the storage system (240) into an existing investment account determined according to the other redemption information.

The various components of the system are in communication with each other. For example, the database (220) is in communication with the activation interface (230), the redemption interface (250), the storage system (240) and the router (260) and vice versa. The activation interface (230) is also in communication with the storage system (240) and vice versa. The redemption interface (250) is also in communication with the router (260) and vice versa. The storage system (240) is also in communication with the router (260).

Certain components of the system (200) may be implemented alone or in combination. For example, the components can be implemented with hardware, firmware, and/or as a set of instructions in software. Certain embodiments may be provided as a set of instructions residing on a computer-readable medium for execution on a general purpose computer or other processing device. Examples of computer-readable mediums include memory, hard disks, DVDs, or CDs. The system may be integrated in various forms and/or may be provided as software and/or other functionality on a computing device, such as a computer. Certain embodiments may omit one or more of the components of the system (200).

The current system (200) is comprised of a gift card (210) having an identifier associated with said gift card (210). As discussed with regard to the apparatus, the gift card (210) could be a plastic card of typical size and shape. The investment gift card can be in the electronic format and exist only in its unique identifier, as discussed above. An example of a card of typical size and shape is a major credit card or ATM card. However, atypical card shapes and sizes are also contemplated. The gift card (210) could have information on the front and/or back faces. Such information could include its source, the denomination of the card, how to use the card, etc.

The gift card (210) could also have themed text, graphics, advertisements, or photos displayed on it. It could also allow the purchaser to personalize the card with personal text, graphics or photos. In addition, a promotional option can be purchased that would compliment the gift card (210). Examples of these promotional items include, but are not limited to, sports team paraphernalia (Chicago Bears hat), college team paraphernalia (Ohio State Buckeye mug), and occupation accessories (doctor smock).

The gift card (210) could be purchased at retail outlets, such as convenience stores, grocery stores, malls and other shopping locations. It could additionally be purchased online, by phone order, by mail order or at a financial institution. In one embodiment, the denomination of money paid for the gift card is customer-specified. In another embodiment, the gift card comes in set denominations, such as $10 increments, $50 increments, $100 increments or $1,000 increments. In one embodiment, a convenience fee could be added to the cost of the gift card. For example, a card having a value of $500 could have a $10 convenience fee. This would increase the cost at the time of purchasing to $510.

The gift card can be applied to numerous different types of existing investment accounts. Possible existing investment accounts include, but are not limited to, 529 college savings plans, IRAs, Roth IRAs, Retirement Accounts, individual stocks, mutual funds, and ETFs. These existing investment accounts are established prior to application of the gift card funds to the investment account. These existing investment accounts are established in the name of the gift card holder using the gift card holder's financial institution, financial advisor and/or financial planner of choice. If an individual does not have an existing 529 college savings account, the customer will be able to search the website for a preferred financial advisor or financial institution to assist in the opening of an account.

The gift card provider does not manage or establish the existing investment accounts. There are numerous benefits of the gift card provider not managing or establishing the investment account. For example, this allows the gift card to be distributed at a national level so that it is available to any individual in any state where laws permit such gift card transactions to occur. It also allows the gift card recipient to use the financial institution, financial advisor and/or financial planner of choice. The recipient is not limited to financial service providers with whom the gift card provider has relationships.

The gift card (210) would also have an identifier associated with the gift card (210). The identifier could be a serial number, a magnetic strip, a scanable barcode, or other identifier known in the gift card industry. The identifier allows information about the gift card to be recorded and tracked.

The gift card can be recorded and tracked using the next component of the system: the database (220). The database (220) associates the identifier with the gift card (210). The database (220) can additionally associate information received from the activation interface (230) and the redemption interface (250) with the gift card (210).

As discussed above, the database is in communication with the activation interface (230). The activation interface (230) obtains information from a gift card holder (at this time typically the purchaser although potentially another individual) in order to activate the gift card. It allows the gift card holder, or another individual acting on behalf of the gift card holder (such as a retail outlet employee), to enter data regarding the gift card into the database (220). Possible data regarding the gift card includes, but is not limited to, the identifier associated with the card, the denomination of money associated with the card (this can be the denomination paid for the card or another amount), and general transaction information. General transaction information could include the purchaser, the intended recipient, the date of purchase, the time of purchase and the method of purchase.

In one embodiment, personal customer information, such as the purchaser's identity, is not obtained during activation. For example, if someone purchases a gift card at a retail outlet, no personal customer information is captured at the register. Only the date of purchase, time of purchase, method of purchase and amount of purchase could be obtained.

The activation interface (230) presents various questions to the gift card holder or individual acting on his or her behalf to obtain this data. The questions could be presented to the gift card holder or individual acting on his or her behalf in a number of different ways. Possible methods of presenting the questions include direct questions by a retail outlet employee who enters the gift card holder's answers, direct questions by a call center operator who enters the gift card holder's answers, a specialized website, a desktop, laptop or handheld computing device that is connected over a network to the database (220), or a home computer using specialized software, for example.

The gift card holder, or individual acting on behalf of the gift card holder, could input his or her answers using an input device, such as a keyboard, a touchscreen, a joystick, a mouse, a touchpad, and/or a microphone.

There can also be other data streams into the database (220) in addition to the data inputted by the activation interface (230), such as streams of data from the gift card seller regarding sale of the gift card.

Using the information from the gift card holder or individual acting on his or her behalf, the activation interface (220) then verifies the identifier offered by the user is associated with a valid gift card (210). The activation interface (220) then associates the denomination of money and any other general transaction information with the gift card (210) and saves that information in the database (220).

The denomination of money received in exchange for the gift card is kept in a storage system (240) until redemption. In one embodiment, the storage system is the gift card supplier's secure financial account. All or part of the denomination of money may be redeemed at the time of redemption. Any remaining funds remain in the storage system (240) until redemption of those remaining funds.

A redemption interface (250) is used when the gift card holder (at this time typically the recipient, although it may be another individual) desires to redeem the gift card (210). As discussed above, the database is in communication with the redemption interface (250). The redemption interface (250) obtains the identifier associated with the gift card (210) and other redemption information from the gift card holder, or another individual acting on behalf of the gift card holder (such as a call center operator). Possible redemption information includes, but is not limited to, the portion of the denomination of money that is to be routed to an existing investment account, an identifier associated with an existing investment account to which the portion of the denomination of money is to be routed, the time of redemption, the place of redemption, the date of redemption, and the manner of redemption.

The redemption interface (250) presents various questions to the gift card holder or individual acting on his or her behalf to obtain this data. The questions could be presented to the gift card holder or individual acting on his or her behalf in a number of different ways. Possible methods of presenting the questions include direct questions by a call center operator who enters the gift card holder's answers, a specialized website, a desktop, laptop or handheld computing device that is connected over a network to the database (220), or a home computer using specialized software, for example.

The gift card holder, or individual acting on behalf of the gift card holder, could input his or her answers using an input device, such as a keyboard, a touchscreen, a joystick, a mouse, a touchpad, and/or a microphone.

There can also be other data streams into the database (220) in addition to the data inputted by the redemption interface (250), such as streams of data from the existing investment account system regarding redemption of the gift card.

Using the information from the gift card holder or individual acting on his or her behalf, the redemption interface (250) then verifies the identifier offered by the user is associated with a valid gift card (210). The redemption interface then communicates with the router (260) to route at least a portion of the denomination of money from the storage system (240) into an existing investment account. The amount of money routed and the existing investment account to which it is routed is determined according to the other redemption information supplied by the user to the redemption interface (250). In one embodiment, the denomination of money is routed from the financial account linked to the gift card provider to the existing investment account associated with the identifier provided by the gift card holder to the redemption interface (250).

The gift card provider does not manage the money in the existing investment account. The gift card holder is a router of the money on the gift card into an existing investment account. The gift card holder who receives the gift card can continue to work with their preferred personal financial advisor or financial institution to open and manage their investment account. Because the gift card provider does not manage money, the gift card holder's money will not be managed by anyone other than the individual he or she has selected to manage his or her money. Thus creating a benefit over systems where the gift card provider establishes the investment account and manages the funds in the investment account.

A transfer relationship is established between the gift card provider and the preferred personal financial advisor and/or investment provider. The preferred personal financial advisor and/or investment provider would grant access to deposit funds into existing accounts. Once the card is redeemed the dollar amount would be routed to the recipient's existing account, for example a 529 college savings account. This process would be done manually using the Automatic Clearing House, ACH, or a by using a third party transfer agent.

The fact that the gift card provider does not manage the money allows the gift card to be distributed at a national level and will be available to any individual in any state where laws permit such gift card transactions to occur. If an individual does not have an existing 529 college or other type of savings account, the customer will be able to search the website for a preferred financial advisor or financial institution to assist in the opening of an account.

The redemption interface (250) can additionally update the database (220) with the redemption information, including any remaining denomination of money associated with said gift card. The remaining balance can then be accessed at a later date using the redemption interface. The remaining balance can be applied to the same existing investment account or another existing investment account.

In one embodiment the gift card holder can add a new denomination of money to the gift card after the original denomination of money has been redeemed. In yet another embodiment, not all of the money has to be redeemed before adding to the balance. Possible ways reloading could occur include online, at a retail outlet, by calling a call center or by mail. In another embodiment the gift card is linked to the purchaser's financial account and it automatically reloads on a regularly scheduled basis (monthly, quarterly, etc) or after the original denomination of money has been redeemed.

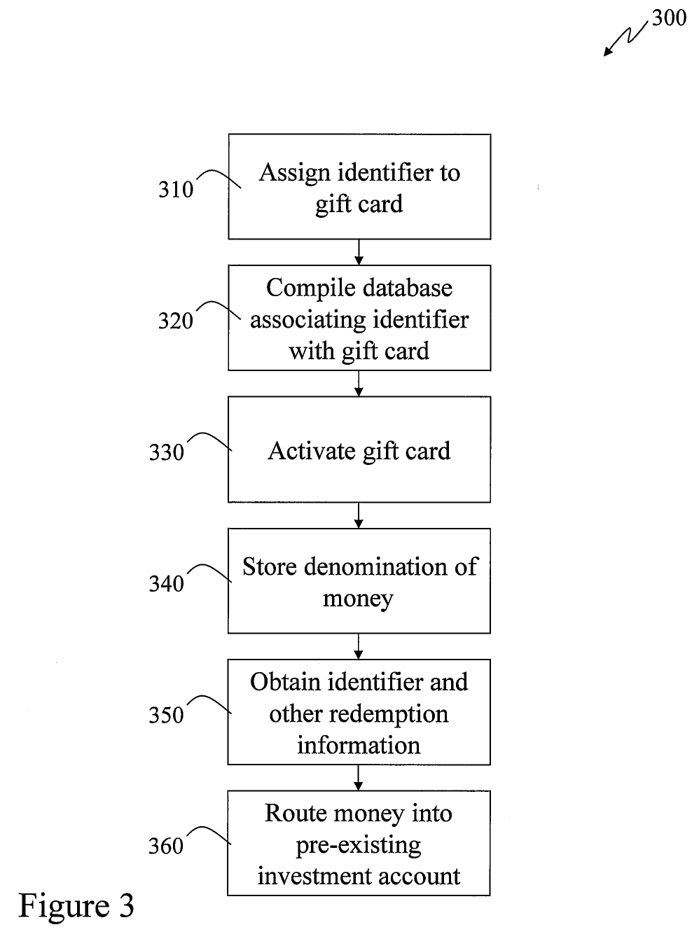

FIG. 3 illustrates a method (300) of loading, activating, and redeeming an investment gift card according to an embodiment of the present technology. The method (300) involves assigning an identifier to a gift card (310); compiling a database wherein the identifier is associated with the gift card (320); activating the gift card by obtaining the identifier associated with the gift card, verifying the identifier is associated with the gift card and associating a denomination of money with the gift card in the database (330); storing the denomination of money until redemption (340); obtaining the identifier associated with the gift card and other redemption information (350); routing at least a portion of the denomination of money from the storage system into an existing investment account determined according to the other redemption information (360).

In the first step of the method, an identifier is assigned to a gift card (310). The gift card may take the form of a gift card, such as (110) and/or (220) discussed above. Similarly the identifier may take the form of an identifier, such as (120) discussed above. The gift card can be a plastic card of typical size and shape, or atypical size and shape. The investment gift card can be in the electronic format and exist only in its unique identifier, as discussed above. The gift card could have information regarding the gift card, text, graphics or photos displayed on it. It could be personalized. It could additionally be available with a themed promotional item.

The gift card could be purchased at retail outlets, online, by phone order, by mail order or at a financial institution. The gift card can be in a customer-specified denomination or be available in set increments. As discussed above, a convenience fee could be added to the cost of the gift card. For example, a card having a value of $500 could have a $10 convenience fee. This would increase the cost at the time of purchasing to $510.

The gift card can be applied to numerous different types of existing investment accounts. Possible existing investment accounts include, but are not limited to, 529 college savings plans, IRAs, Roth IRAs, Retirement Accounts, individual stocks, mutual funds, and ETFs. These existing investment accounts are established prior to application of the gift card funds to the investment account. These existing investment accounts are established in the name of the gift card holder using the gift card holder's financial institution, financial advisor and/or financial planner of choice. If an individual does not have an existing 529 college savings account, the customer will be able to search the website for a preferred financial advisor or financial institution to assist in the opening of an account.

The gift card provider does not manage or establish the existing investment accounts. There are numerous benefits of the gift card provider not managing or establishing the investment account. For example, this allows the gift card to be distributed at a national level so that it is available to any individual in any state where laws permit such gift card transactions to occur. It also allows the gift card recipient to use the financial institution, financial advisor and/or financial planner of choice. The recipient is not limited to financial service providers with whom the gift card provider has relationships.

The identifier associated with the gift card could be a serial number, a magnetic strip, a scanable barcode, or other identifier known in the gift card industry. The identifier allows information about the gift card to be recorded and tracked.

In the next step, a database is compiled wherein the identifier is associated with the gift card (320). The database may take the form of a database, such as (220) discussed above. The database associates the identifier with the gift card. The database can additionally associate other information with the gift card, such as information received from the activation and redemption of the gift card.

In the third step, the gift card is activated by obtaining the identifier associated with the gift card, verifying the identifier is associated with the gift card and associating a denomination of money with the gift card in the database (330). The activation can be carried out by an activation interface, such as (230) described above. During activation, data regarding the gift card is obtained from the gift card holder, or another individual acting on behalf of the gift card holder (such as a retail outlet employee). At this point in the process, the gift card holder is typically the purchaser of the gift card, although it could potentially be another individual. Possible data regarding the gift card includes, but is not limited to, the identifier associated with the card, the denomination of money associated with the card (this can be the denomination paid for the card or another amount), and general transaction information. General transaction information could include the purchaser, the intended recipient, the date of purchase, the time of purchase and the method of purchase. The data regarding the gift card can be associated with the gift card and saved in the database.

In one embodiment, personal customer information, such as the purchaser's identity, is not obtained during activation. For example, if someone purchases a gift card at a retail outlet, no personal customer information is captured at the register. Only the date of purchase, time of purchase, method of purchase and amount of purchase could be obtained.

During activation, various questions are presented to the gift card holder or individual acting on his or her behalf. The questions could be presented through direct questions by a retail outlet employee who enters the gift card holder's answers, direct questions by a call center operator who enters the gift card holder's answers, a specialized website, a desktop, laptop or handheld computing device that is connected over a network to the database, or a home computer using specialized software, for example. The gift card holder, or individual acting on behalf of the gift card holder, could input his or her answers using an input device, such as a keyboard, a touchscreen, a joystick, a mouse, a touchpad, and/or a microphone. There can also be other data streams into the database, such as streams of data from the gift card seller regarding sale of the gift card.

After the identifier associated with said gift card has been obtained from the gift card holder, the database is used to verify that the identifier is associated with a valid gift card. The denomination of money and any other general transaction information is then associated with the gift card saved in the database.

In the fourth step, the denomination of money is stored until redemption (340). The money can be stored using a storage system, such as 240 discussed above. The denomination of money received in exchange for the gift card is stored until redemption. In one embodiment, the denomination of money is stored in the gift card supplier's secure financial account. All or part of the denomination of money may be redeemed at the time of redemption. Any remaining funds will continue to be stored until redemption of those remaining funds.

In the fifth step, the identifier associated with the gift card and other redemption information is obtained (350). The redemption can be carried out using a redemption interface, such as (250) described above. Redemption occurs when the gift card holder desires to redeem the gift card. At this point in the process the gift card holder is typically the recipient of the gift card, although it may be another individual. During redemption the identifier associated with the gift card and other redemption information is obtained from the gift card holder, or another individual acting on behalf of the gift card holder (such as a call center operator). Possible redemption information includes, but is not limited to, the portion of the denomination of money that is to be routed to an existing investment account, an identifier associated with the existing investment account to which the portion of the denomination of money is to be routed, the person redeeming, the time of redemption, the place of redemption, the date of redemption, and the manner of redemption.

During redemption, data is obtained from the gift card holder or person acting on his or her behalf. This data could be obtained by direct questions by a call center operator who enters the gift card holder's answers, a specialized website, a desktop, laptop or handheld computing device that is connected over a network to the database, or a home computer using specialized software, for example. The gift card holder, or individual acting on behalf of the gift card holder, could input his or her answers using an input device, such as a keyboard, a touchscreen, a joystick, a mouse, a touchpad, and/or a microphone. There can also be other data streams into the database, such as streams of data from the existing investment account system regarding redemption of the gift card.

After the identifier associated with said gift card has been obtained from the gift card holder, the database can be used to verify that the identifier is associated with a valid gift card.

In the sixth step, at least a portion of the denomination of money from the storage system is routed into an existing investment account determined according to the other redemption information (360). The routing can be carried out using a router, such as (260) discussed above. At least a portion of the denomination of money from the storage system is then routed into an existing investment account. The amount of money routed and the existing investment account to which it is routed is determined according to the other redemption information supplied by the user during redemption. In one embodiment, the denomination of money is routed from the financial account linked to the gift card provider to the existing investment account associated with the identifier provided by the gift card holder during redemption.

The gift card provider does not manage the money in the existing investment account. The gift card holder is a router of the money on the gift card into an existing investment account. The gift card holder who receives the gift card can continue to work with their preferred personal financial advisor or financial institution to open and manage their investment account. Because the gift card provider does not manage money, the gift card holder's money will not be managed by anyone other than the individual he or she has selected to manage his or her money. This gift card will be distributed at a national level and will be available to any individual in any state where laws permit such gift card transactions to occur.

A transfer relationship is established between the gift card provider and the preferred personal financial advisor and/or investment provider. The preferred personal financial advisor and/or investment provider would grant access to deposit funds into existing accounts. Once the card is redeemed the dollar amount would be routed to the recipient's existing account, for example a 529 college savings account. This process would be done manually using the Automatic Clearing House, ACH, or a by using a third party transfer agent.

After the denomination of money has been routed the database can additionally be updated with the redemption information, including any remaining denomination of money associate with said gift card. The remaining balance can then be accessed at a later date using the redemption interface. The remaining balance can be applied to the same existing investment account or another existing investment account.

In one embodiment the gift card holder can add a new denomination of money to the gift card after the original denomination of money has been redeemed. Possible ways reloading could occur include online, at a retail outlet, by calling a call center or by mail. In another embodiment the gift card is linked to the purchaser's financial account and it automatically reloads on a regularly scheduled basis (monthly, quarterly, etc.) or after the original denomination of money has been redeemed.

One or more of the steps of the methods (300) may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments may be implemented in one or more of the systems described above. For example, certain embodiments of the method (300) may be implemented using one or more local electronic record systems, a database or other data storage storing electronic data, and one or more user interfaces facilitating capturing, integrating and/or analyzing information inputted by the user.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

In one example, an individual purchases a $500 investment gift card as a graduation gift. The card is purchased at a retail outlet. The gift card is available in increments of $100, i.e. $100, $200, etc. The gift card says “Congratulations”, has a picture of a college mascot on the face and comes with a mug displaying the logo for the same college. A convenience fee could be added to the cost of the gift card. In this example, the $500 could have a $10 convenience fee. This would increase the cost at the time of purchasing to $510.

The gift card has a unique serial number associated with that gift card. That unique serial number is stored in a database with the serial numbers of other gift cards. When purchasing the gift card the retail outlet employee enters the serial number into the activation interface. This verifies that the number is associated with a valid gift card. The retail outlet employee then enters information regarding the transaction (date, time, place, identity of purchaser, name of recipient, method of purchase, etc.) and the denomination of money associated with the card, $500. The $500 is stored in the secure financial account belonging to the gift card provider.

The purchasing individual gives the gift to the recipient, a high school graduate planning on attending the college whose mascot displayed on the card. The gift card recipient can then use a specialized website to redeem the gift card. The specialized website allows the recipient to input the serial number. The serial number is verified. The recipient then inputs the specific portion of the $500 that she wants to invest and the identification number of the existing investment account into which she wishes to invest the money. For example, she can input that she wants $250 put into her 529 college savings plan. The $250 is then routed from the financial account belonging to the gift card provider to her 529 college savings plan. The remaining $250 remains in the financial account belonging to the gift card provider until the recipient redeems that amount. She can use the rest of the card with her 529 college savings account or another existing investment account.

In another example, the gift card recipient can contact the gift card provider call center to redeem the gift card. The call center operator obtains the unique serial number from the recipient. The serial number is verified. The recipient then tells the call center operator the specific portion of the $500 that she wants to invest and the identification number of the existing investment account into which she wishes to invest the money. For example, she can indicate to the call center operator that she wants $250 put into her 529 college savings plan. The call center operator inputs the data and the $250 is then routed from the financial account belonging to the gift card provider to her 529 college savings plan. The remaining $250 remains in the financial account belonging to the gift card provider until the recipient redeems that amount. She can use the rest of the card with her 529 college savings account or another existing investment account.

As another example, an individual purchases a $555 investment gift card as a birthday gift. The card is purchased at a specialized website. The purchaser specifies the denomination of money she would like to spend for the card. The card has a personalized message, a picture of the recipient playing in a pee wee football uniform and comes with a promotional football jersey.

The gift card has a scanable bar code associated with that gift card. That scanable bar code identification is stored in a database with the scanable bar code identification of other gift cards. The card is activated at the gift card provider company. The scanable bar code is verified to make sure it is associated with a valid card. The denomination of money on the card, $555, and the transaction information is then associated with the card and saved in the database. The card and promotion gift are then mailed to the recipient. The $555 is stored in the secure financial account belonging to the gift card provider.

The gift card recipient can then take the card to a financial institution, such as a bank. The card is scanned. The scanable bar code is verified. The recipient then tells the bank teller the specific portion of the $555 that she wants to invest and the identification number of the existing investment account into which she wishes to invest the money. She chooses to invest $555 into a mutual fund account. The teller inputs this data and the money is routed to her mutual fund account. The recipient or purchaser can then reload the card online if desired.

In another example, an individual purchases a $500 investment gift card as a graduation gift. The card is purchased at a retail outlet. The gift card is available in increments of $100, i.e. $100, $200, etc. The gift card says “Congratulations”, has a picture of a college mascot on the face and comes with a mug displaying the logo for the same college.

The gift card has a scanable bar code associated with that gift card. That scanable bar code identification is stored in a database with the scanable bar code identification of other gift cards. The card is activated at the gift card provider company. The scanable bar code is verified to make sure it is associated with a valid card. The denomination of money on the card, $500, and the transaction information is then associated with the card and saved in the database. The card and promotion gift are then mailed to the recipient. The $500 is stored in the secure financial account belonging to the gift card provider.

The gift card recipient can then take the card to a financial institution, such as a bank. The card is scanned. The scanable bar code is verified. The recipient then tells the bank teller the specific portion of the $500 that she wants to invest and the identification number of the existing investment account into which she wishes to invest the money. She chooses to invest $500 into a mutual fund account. The teller inputs this data and the money is routed to her mutual fund account. The recipient or purchaser can then reload the card online if desired.

As another example, an individual purchases a $555 investment gift card as a birthday gift. The card is purchased at a specialized website. The purchaser specifies the denomination of money she would like to spend for the card. The card has a personalized message, a picture of the recipient playing in a pee wee football uniform and comes with a promotional football jersey.

The gift card has a unique serial number associated with that gift card. That unique serial number is stored in a database with the serial numbers of other gift cards. When purchasing the gift card the retail outlet employee enters the serial number into the activation interface. This verifies that the number is associated with a valid gift card. The retail outlet employee then enters information regarding the transaction (date, time, place, identity of purchaser, name of recipient, method of purchase, etc.) and the denomination of money associated with the card, $555. The $555 is stored in the secure financial account belonging to the gift card provider.

The purchasing individual gives the gift to the recipient, a high school graduate planning on attending the college whose mascot displayed on the card. The gift card recipient can then use a specialized website to redeem the gift card. The specialized website allows the recipient to input the serial number. The serial number is verified. The recipient then inputs the specific portion of the $555 that she wants to invest and the identification number of the existing investment account into which she wishes to invest the money. For example, she may want to add $250 to her 529 college savings plan. The $250 is then routed from the financial account belonging to the gift card provider to her 529 college savings plan. The remaining $305 remains in the financial account belonging to the gift card provider until the recipient redeems that amount. She can use the rest of the card with her 529 college savings account or another existing investment account.

Thus, certain embodiments provide the technical effect of loading, activating, and redeeming an investment gift card.

While particular elements, embodiments and applications of the present invention have been shown and described, it will be understood, of course, that the invention is not limited thereto since modifications can be made by those skilled in the art without departing from the scope of the present disclosure, particularly in light of the foregoing teachings.

1. A system for loading, activating, and redeeming an investment gift card comprising:
a gift card having an identifier associated with said gift card;
a database wherein said database associates said identifier with said gift card;
an activation interface wherein said activation interface obtains said identifier associated with said gift card, verifies said identifier is associated with said gift card and associates a denomination of money with said gift card in said database;
a storage system wherein said storage system stores said denomination of money until redemption;
a redemption interface wherein said redemption interface obtains said identifier associated with said gift card and other redemption information;
a router wherein said router routes at least a portion of said denomination of money from said storage system into an existing investment account determined according to said other redemption information.

2. The system of claim 1 wherein said existing investment account is a 529 college savings plan.

3. The system of claim 1 wherein said identifier is a serial number.

4. The system of claim 1 wherein said activation interface is located at a retail outlet.

5. The system of claim 1 wherein said activation interface is available online.

6. The system of claim 1 wherein said redemption interface is available online.

7. The system of claim 1 wherein said redemption interface is a available through a call center.

8. The system of claim 1 wherein said other redemption information includes a portion of said denomination of money that is to be routed to said existing investment account.

9. The system of claim 8 wherein said redemption interface additionally updates said database with redemption information.

10. The system of claim 9 wherein said redemption information is selected from the group comprising redemption time, redemption date, redemption method, and available gift card balance.

11. The system of claim 1 wherein said other redemption information includes an identifier associated with said existing investment account.

12. The system of claim 1 wherein said denomination of money associated with said gift card is customer-specified.

13. The system of claim 1 wherein said activation interface additionally associates other general transaction information with said gift card in said database.

14. The system of claim 13 wherein said other general transaction information is selected from the group comprising purchaser, date of purchase, time of purchase and method of purchase.

15. The system of claim 1 wherein said gift card is personalized using graphics, text, or photos.

16. The system of claim 1 wherein said gift card is coupled with a themed promotional gift.

17. The system of claim 1 wherein said gift card is reloadable.

18. The system of claim 1 wherein said gift card automatically reloads.

19. The system of claim 1 wherein said gift card is an electronic gift card.

20. A method of loading, activating, and redeeming an investment gift card comprising:
assigning an identifier to a gift card;
compiling a database wherein said identifier is associated with said gift card;
activating said gift card by obtaining said identifier associated with said gift card;
verifying said identifier is associated with said gift card and associating a denomination of money with said gift card in said database;
storing said denomination of money until redemption;
obtaining said identifier associated with said gift card and other redemption information;
routing at least a portion of said denomination of money from said storage system into an existing investment account determined according to said other redemption information.

21. The method of claim 20 wherein the steps are performed sequentially.

22. A computer-readable medium having a set of instructions for execution by a computer, the set of instruction comprising:
an identification routine configured to assign an identifier to a gift card;
a compilation routine configured to compile a database wherein said identifier is associated with said gift card;
an activation routine configured to activate said gift card by obtaining said identifier associated with said gift card, verifying said identifier is associated with said gift card and associating a denomination of money with said gift card in said database;
a storage routine configured to store said denomination of money until redemption;
a redemption routine configured to obtain said identifier associated with said gift card and other redemption information;
a routing routine configured to route at least a portion of said denomination of money from said storage system into an existing investment account determined according to said other redemption information.
